(19) United States
(12) Patent Application Publication
(10) Pub. No.: US 2025/0375057 A1
(43) Pub. Date: Dec. 11, 2025

(54) Heated Dish Device

(71) Applicant: Kenneth Hutchinson, Cypress, TX (US)

(72) Inventor: Kenneth Hutchinson, Cypress, TX (US)

(21) Appl. No.: 18/737,216

(22) Filed: Jun. 7, 2024

(51) Int. Cl. A47J 27/00

(52) U.S. Cl. CPC A47J 27/004

(57) ABSTRACT

A heated dish device for warming food within the dish includes a wall that is curved wherein the wall is designed to hold a fluid. A power source is positioned within the wall. A heating element is positioned within the wall. The heating element is electrically coupled to the power source wherein the power source actuates the heating element. The heating element is actuatable to increase a temperature of the wall wherein the heating element is designed to increase a temperature of the fluid.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dishes and more particularly pertains to a new dish for warming food within the dish.

### (2) Description of Related Art Including Information Disclosed Under 37 CFR 1.97 and 1.98

The prior art relates to dishes. Dishes are used to serve, present, and hold food. For example, bowls are often used to hold foods like queso, sauces, soups, and pastas. Oftentimes, people prefer to eat those foods when those foods are hot. For example, a person may microwave a bowl of queso so that the person can enjoy the queso when it is hot. When the person is eating slowly, or over an extended period of time, the food within the bowl will eventually cool to ambient temperatures. The person may then need to microwave the bowl of food again. Thus, it would be useful to have a bowl with an integrated heating element that can be used to keep the food hot while the food is sitting in the bowl. Such a device would be particularly useful if the device had a rechargeable power source and if the device could easily be washed without damaging the power source or the heating element.

### BRIEF SUMMARY OF THE INVENTION

An embodiment of the disclosure meets the needs presented above by generally comprising a wall being curved wherein the wall is configured to hold a fluid. A power source is positioned within the wall. A heating element is positioned within the wall. The heating element is electrically coupled to the power source wherein the power source actuates the heating element. The heating element is actuatable to increase a temperature of the wall wherein the heating element is configured to increase a temperature of the fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a heated dish device according to an embodiment of the disclosure.

FIG. 2 is a side view of an embodiment of the disclosure.

FIG. 3 is an in-use view of an embodiment of the disclosure.

FIG. 4 is a block diagram view of an embodiment of the disclosure.

### DETAILED DESCRIPTION OF THE INVENTION

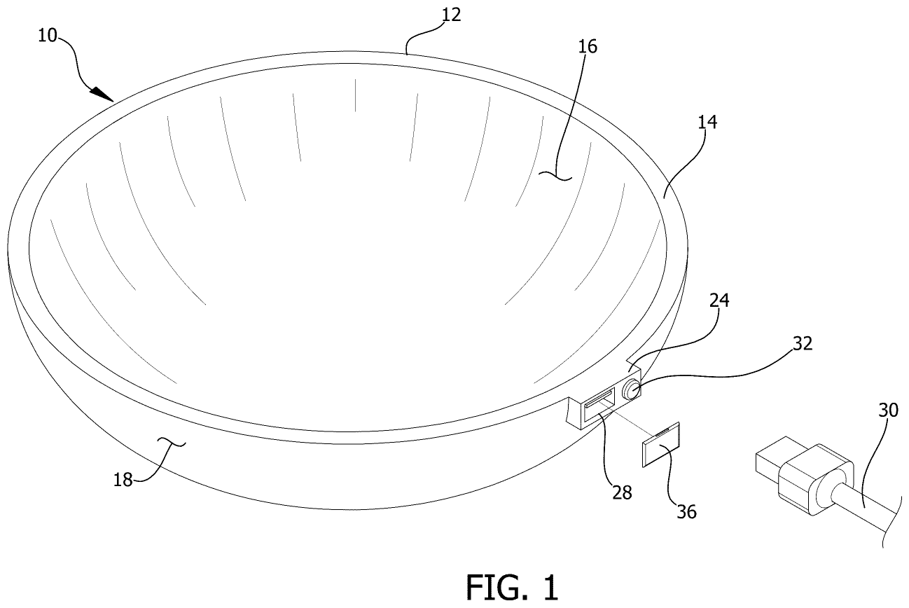

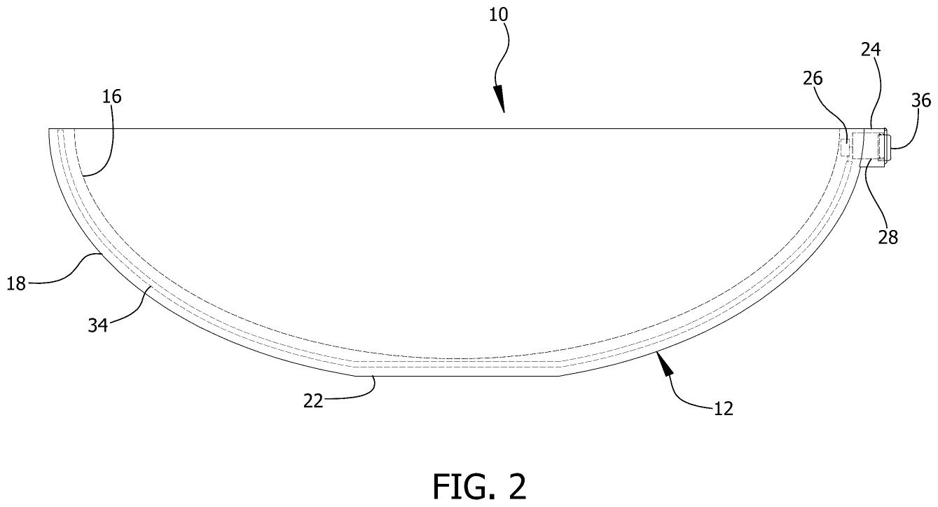

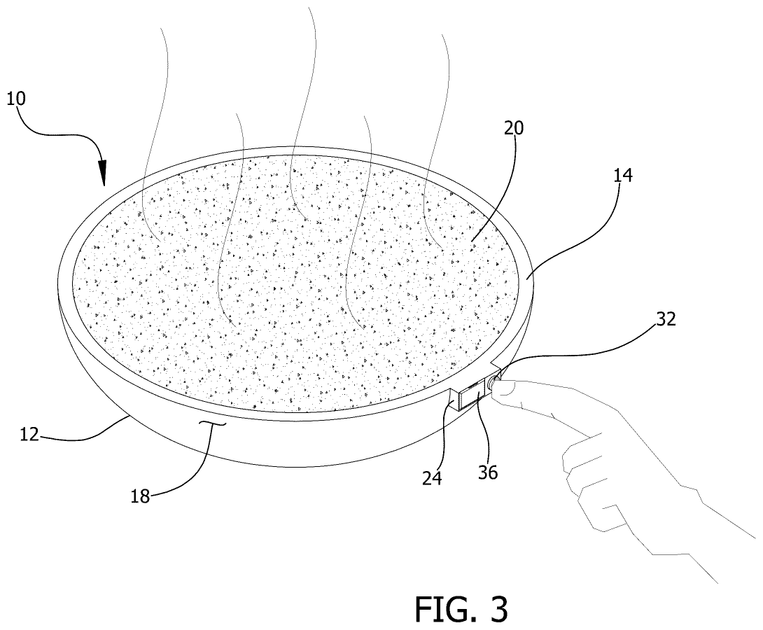

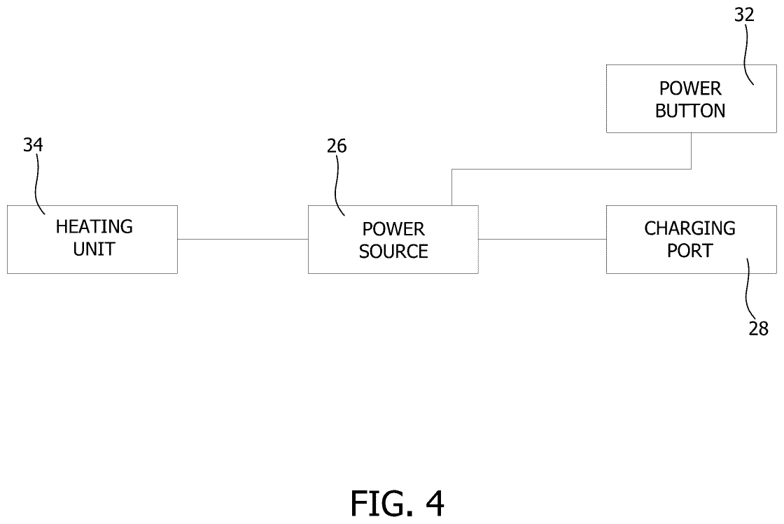

With reference now to the drawings, and in particular to FIGS. 1 through 4 thereof, a new dish embodying the principles and concepts of an embodiment of the disclosure and generally designated by the reference numeral 10 will be described.

As best illustrated in FIGS. 1 through 4, the heated dish device 10 generally comprises a wall 12. The wall 12 generally includes an upper edge 14. The wall 12 is generally curved to define a concave side 16 and a convex side 18 wherein the wall 12 is configured to hold a fluid 20 on the concave side 16.

A planar section 22 may be positioned on the convex side 18 of the wall 12. The planar section 22 is generally configured for placement on a planar support surface, such as a table or a countertop. The planar section 22 is generally spaced from the upper edge 14.

A hub 24 may be coupled to the wall 12. For example, the hub 24 may be positioned adjacent to the upper edge 14, although alternative positions are also contemplated. The hub 24 generally extends outwardly from the convex side 18 of the wall 12.

A power source 26 is positioned within the wall 12 between the concave side 16 and the convex side 18. A charging port 28 may be electrically coupled to the power source 26. The charging port 28 is generally configured to receive a charging cable 30 to transfer power to the power source 26. For example, the charging port 28 may be configured to receive a universal serial bus cable. The charging port 28 may be inset into the hub 24. In such embodiments, the charging port 28 may be exposed within the hub 24, as shown in FIG. 1. Alternatively, the charging port 28 may be inset into and exposed within the wall 12.

A power button 32 may be electrically coupled to the power source 26. The power button 32 may be positioned on the hub 24 adjacent to the charging port 28. Alternatively, the power button 32 may be positioned on the wall 12.

A heating element 34 is positioned within the wall 12. The heating element 34 is generally positioned between the concave side 16 and the convex side 18, wherein the heating element is integrated into the wall 12. The heating element 34 is electrically coupled to the power source 26. The power source 26 may actuate the heating element 34 when the power button 32 is manipulated.

Once actuated, the heating element 34 can increase a temperature of the wall 12. By increasing the temperature of the wall, the heating element 34 is configured to increase a temperature of the fluid 20 that is held on the concave side 16 of the wall 12. For example, the heating element 34 may be coextensive with the concave side 16 wherein the heating element 34 is configured to heat all of the concave side 16. Such embodiments may be designed to evenly heat the fluid 20.

A cover 36 may be removably couplable to the hub 24. The cover 36 may alternatively be removably couplable to the wall 12. The cover 36 is generally positionable to cover 36 the charging port 28. The cover 36 may be sealed wherein the cover 36 is configured to inhibit penetration of water into the charging port 28. For example, when a user is washing or cleaning the wall 12, the user may position the cover 36 over the charging port 28 to inhibit penetration of water into the charging port 28, which can damage the charging port 28 and the other electrical components, namely, the power source 26 and the heating element 34.

In use, the fluid 20 may include a soup, a queso, a pasta, or any other substance that the user wishes to warm up within the heated dish device 10. When the user presses the power button 32, the heating element 34 will turn on to increase the temperature of the wall 12 and warm the fluid 20 that is held on the concave side 16. To recharge the power source 26, the user can connect the charging cable 30 to the charging port 28. When the user is washing the heated dish device 10, the user can position the cover 36 to cover 36 the charging port 28. The heated dish device 10 may include materials that can be repeatedly washed and heated, such as plastic and metal materials.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated bowl assembly comprising:
a wall being curved wherein the wall is configured to hold a fluid;
a power source being positioned within the wall; and
a heating element being positioned within the wall, the heating element being electrically coupled to the power source wherein the power source actuates the heating element, the heating element being actuatable to increase a temperature of the wall wherein the heating element is configured to increase a temperature of the fluid.

2. The heated bowl assembly of claim 1, the wall further comprising a concave side and a convex side, the heating element being positioned within the wall between the concave side and the convex side.

3. The heated bowl assembly of claim 2, wherein the power source is positioned within the wall between the concave side and the convex side.

4. The heated bowl assembly of claim 2, wherein the heating element is coextensive with the concave side wherein the heating element is configured to heat all of the concave side.

5. The heated bowl assembly of claim 2, further comprising a planar section being positioned on the convex side of the wall wherein the planar section is configured for placement on a planar support surface.

6. The heated bowl assembly of claim 1, further comprising a hub being coupled to the wall.

7. The heated bowl assembly of claim 6, wherein the hub extends outwardly from the convex side of the wall.

8. The heated bowl assembly of claim 7, further comprising a charging port being electrically coupled to the power source, the charging port being configured to receive a charging cable to transfer power to the power source, the charging port being inset into the hub, the charging port being exposed within the hub.

9. The heated bowl assembly of claim 8, further comprising a cover being removably couplable to the hub, the cover being positionable to cover the charging port, the cover being sealed wherein the cover is configured to inhibit penetration of water into the charging port.

10. The heated bowl assembly of claim 6, further comprising a power button being electrically coupled to the power source, the power button being positioned on the hub adjacent to the charging port, the power source actuating the heating element when the power button is manipulated.

11. The heated bowl assembly of claim 1, further comprising a charging port being electrically coupled to the power source, the charging port being configured to receive a charging cable to transfer power to the power source, the charging port being inset into the wall, the charging port being exposed within the wall.

12. The heated bowl assembly of claim 11, further comprising a cover being removably couplable to the wall, the cover being positionable to cover the charging port.

13. The heated bowl assembly of claim 1, further comprising a power button being electrically coupled to the power source, the power button being actuatable to actuate the heating element.

14. A heated bowl assembly comprising:
a wall having an upper edge, the wall being curved to define a concave side and a convex side wherein the wall is configured to hold a fluid on the concave side;
a planar section being positioned on the convex side of the wall wherein the planar section is configured for placement on a planar support surface, the planar section being spaced from the upper edge;
a hub being coupled to the wall, the hub being positioned adjacent to the upper edge, the hub extending outwardly from the convex side of the wall;
a power source being positioned within the wall between the concave side and the convex side;
a charging port being electrically coupled to the power source, the charging port being configured to receive a charging cable to transfer power to the power source, the charging port being inset into the hub, the charging port being exposed within the hub;
a power button being electrically coupled to the power source, the power button being positioned on the hub adjacent to the charging port;
a heating element being positioned within the wall between the concave side and the convex side, the heating element being electrically coupled to the power source wherein the power source actuates the heating element when the power button is manipulated, the heating element increasing a temperature of the wall wherein the heating element is configured to increase a temperature of the fluid being held within the wall, the heating element being coextensive with the concave side wherein the heating element is configured to heat all of the concave side; and
a cover being removably couplable to the hub, the cover being positionable to cover the charging port, the cover being sealed wherein the cover is configured to inhibit penetration of water into the charging port.
